(19) United States
(12) Patent Application Publication
(10) Pub. No.: US 2013/0155574 A1
(43) Pub. Date: Jun. 20, 2013

(54) MULTILAYER CERAMIC ELECTRONIC COMPONENT

(71) Applicants: Min Cheol PARK, Gwangmyeong (KR); Byoung Hwa Lee, Seongnam (KR); Dong Seok Park, Seoul (KR); Young Ghyu Ahn, Yongin (KR); Sang Soo Park, Suwon (KR)

(72) Inventors: Min Cheol PARK, Gwangmyeong (KR); Byoung Hwa Lee, Seongnam (KR); Dong Seok Park, Seoul (KR); Young Ghyu Ahn, Yongin (KR); Sang Soo Park, Suwon (KR)

(73) Assignee: Samsung Electro-Mechanics Co., Ltd.

(21) Appl. No.: 13/541,494

(22) Filed: Jul. 3, 2012

(30) Foreign Application Priority Data
Dec. 19, 2011 (KR) 10-2011-0137249

(51) Int. Cl. H01G 4/012

(52) U.S. Cl. 361/321.3

(57) ABSTRACT

A multilayer ceramic electronic component having high reliability by reducing equivalent series resistance (ESR) dispersion is provided. Connectivity between internal electrodes and external electrodes is secured by introducing dummy electrodes connected to first and second terminal electrodes, to third and fourth internal electrode layers. ESR dispersion of the multilayer ceramic electronic component is reduced to obtain high reliability.

### CROSS-REFERENCE TO RELATED APPLICATIONS

This application claims the priority of Korean Patent Application No. 10-2011-0137249 filed on Dec. 19, 2011, in the Korean Intellectual Property Office, the disclosure of which is incorporated herein by reference.

### BACKGROUND OF THE INVENTION

1. Field of the Invention

The present invention relates to a multilayer ceramic electronic component and, more particularly, to a multilayer ceramic electronic component in which equivalent series resistance (ESR) dispersion is low (namely, precision is high), thus allowing for high reliability therein.

2. Description of the Related Art

Recently, as an operating frequency of a micro-processor unit (MPU) has increased, a load current therein has been significantly changed.

Thus, it is necessary to increase the capacitance and equivalent series resistance (ESR) of a decoupling capacitor used in an MPU power distribution network while reducing the equivalent series inductance (ESL) thereof.

This is carried out so as to maintain low level uniform impedance in the power distribution network in a broadband frequency range and eventually suppress noise in supplied DC voltage, according to a sudden change in a load current.

In order to enhance ESR, there has been an attempt to utilize internal electrodes connected only to external electrodes and internal electrodes connected to both of terminal electrodes and external electrodes. In this respect, however, ESR is inversely proportional to the number of laminations of the internal electrodes and, recently, the number of laminated internal electrode layers has been increased, so there is a limitation in increasing ESR through such a method.

Also, in order to enhance ESR, there has been an attempt to reduce the number of internal electrode layers connected to both the terminal electrodes and the external electrodes or to change the shape of the internal electrodes, but this method has a problem in which the connectivity of the portions in which the terminal electrodes and the internal electrodes are connected may be degraded, to increase ESR dispersion in a product, thus making it difficult to predict the electrical characteristics thereof, resulting in decreased reliability.

### SUMMARY OF THE INVENTION

An aspect of the present invention provides a multilayer ceramic electronic component having low ESR dispersion, resulting in high reliability.

According to an aspect of the present invention, there is provided a multilayer ceramic electronic component including: a ceramic main body in which internal electrodes are disposed in a laminated manner; first and second terminal electrodes formed lengthwise on the ceramic main body; and first and second external electrodes formed widthwise on the ceramic main body, wherein the internal electrodes include a first internal electrode connected to both of a first terminal electrode and a first external electrode, a second internal electrode connected to both of a second external electrode and a second terminal electrode, a third internal electrode connected only to the first external electrode, and a fourth internal electrode connected only to the second external electrode, and a first dummy electrode connected to the first terminal electrode or a second dummy electrode connected to the second terminal electrode are disposed on at least one of a layer on which the third internal electrode is disposed and a layer on which the fourth internal electrode is disposed.

Any one of the first and second dummy electrodes may be disposed on the layer on which the third internal electrode is disposed and the layer on which the fourth internal electrode is disposed.

The first and second dummy electrodes may be disposed in an alternating manner such that they do not overlap each other.

A ratio of the length of a connection in which the first dummy electrode and the first terminal electrode are connected to the width of the first terminal electrode and a ratio of the length of a connection portion in which the second dummy electrode and the second terminal electrode are connected to the width of the second terminal electrode may range from 0.3 to 0.8.

The first and second dummy electrodes may be disposed together on the layer on which the third internal electrode is disposed and on the layer on which the fourth internal electrode is disposed.

A ratio of the length of a connection in which the first dummy electrode and the first terminal electrode are connected to the width of the first terminal electrode and a ratio of the length of a connection portion in which the second dummy electrode and the second terminal electrode are connected to the width of the second terminal electrode may range from 0.2 to 0.8.

The first and second dummy electrodes may be divided into a plurality of parts.

The first to fourth internal electrodes and the first and second dummy electrodes may be made of the same material.

According to another aspect of the present invention, there is provided a multilayer ceramic electronic component including: a ceramic main body in which internal electrodes are disposed in a laminated manner; first and second external electrodes formed lengthwise on the ceramic main body; and first and second terminal electrodes formed widthwise on the ceramic main body, wherein the internal electrodes include a first internal electrode connected to both of a first terminal electrode and a first external electrode, a second internal electrode connected to both of a second external electrode and a second terminal electrode, a third internal electrode connected only to the first external electrode, and a fourth internal electrode connected only to the second external electrode, and a first dummy electrode connected to the first terminal electrode or a second dummy electrode connected to the second terminal electrode are disposed on at least one of a layer on which the third internal electrode is disposed and a layer on which the fourth internal electrode is disposed.

Any one of the first and second dummy electrodes may be disposed on the layer on which the third internal electrode is disposed and the layer on which the fourth internal electrode is disposed.

The first and second dummy electrodes may be disposed in an alternating manner, such that they do not overlap each other.

A ratio of the length of a connection in which the first dummy electrode and the first terminal electrode are connected to the width of the first terminal electrode and a ratio of the length of a connection portion in which the second dummy electrode and the second terminal electrode are connected to the width of the second terminal electrode may range from 0.4 to 0.8.

The first and second dummy electrodes may be disposed together on the layer on which the third internal electrode is disposed and on the layer on which the fourth internal electrode is disposed.

A ratio of the length of a connection in which the first dummy electrode and the first terminal electrode are connected to the width of the first terminal electrode and a ratio of the length of a connection portion in which the second dummy electrode and the second terminal electrode are connected to the width of the second terminal electrode may range from 0.3 to 0.8.

The first and second dummy electrodes may be divided into a plurality of parts.

The first to fourth internal electrodes and the first and second dummy electrodes may be made of the same material.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing an external appearance of a multilayer ceramic component according to an embodiment of the present invention.

FIG. 2 is a plan view of each internal electrode taken along line A-A′ in FIG. 1 (in the case that a single dummy electrode is provided).

FIG. 3 is an exploded perspective view of the internal electrodes of FIG. 1.

FIG. 4 is a plan view of each internal electrode taken along line A-A′ in FIG. 1 (in the case that two dummy electrodes are provided).

FIG. 5 is a graph showing ESR dispersion in the multilayer ceramic electronic component according to an embodiment of the present invention.

FIG. 6 is a perspective view showing an external appearance of a multilayer ceramic component according to another embodiment of the present invention.

FIG. 7 is a plan view of each internal electrode taken along line B-B′ in FIG. 6 (in the case that a single dummy electrode is provided).

FIG. 8 is an exploded perspective view of each internal electrode of FIG. 1.

FIG. 9 is a plan view of each internal electrode taken along line B-B′ in FIG. 6 (in the case that two dummy electrodes are provided).

### DETAILED DESCRIPTION OF EMBODIMENTS

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

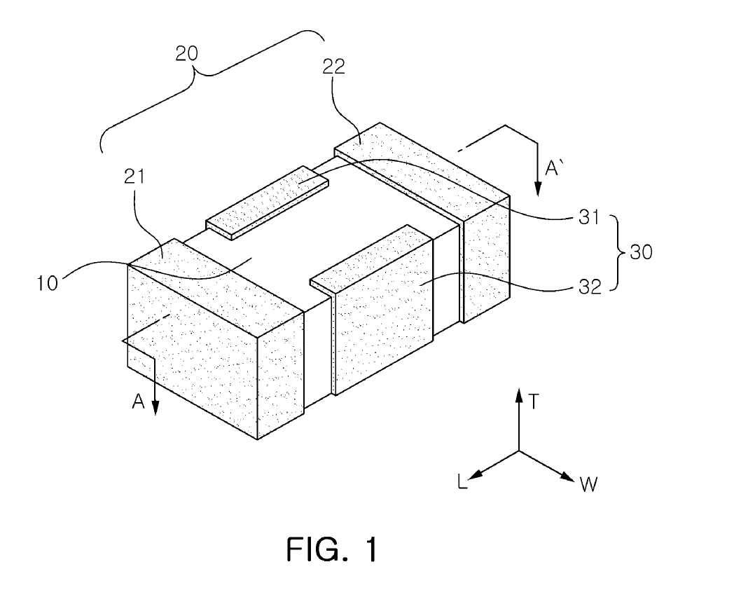

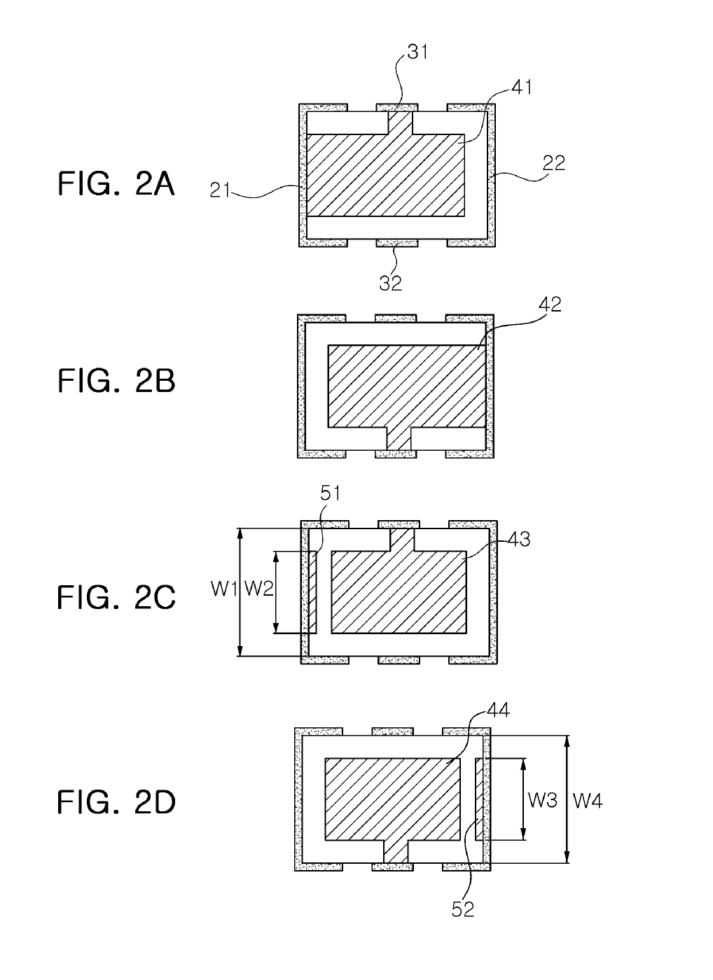

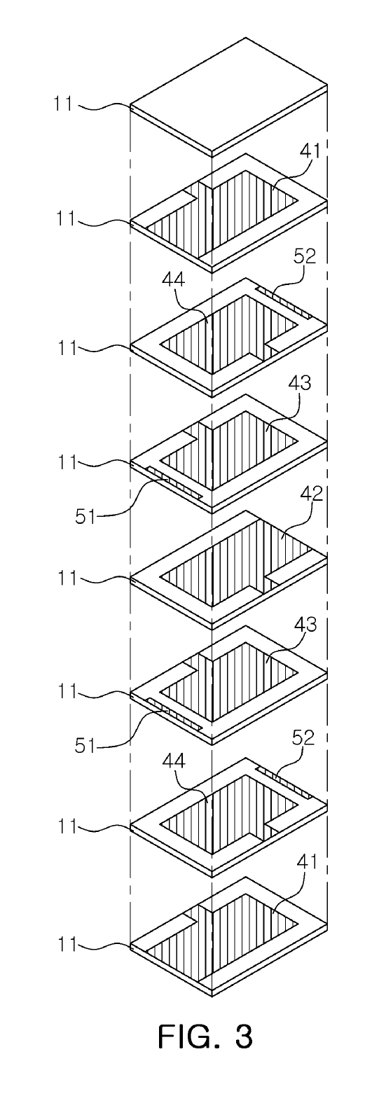

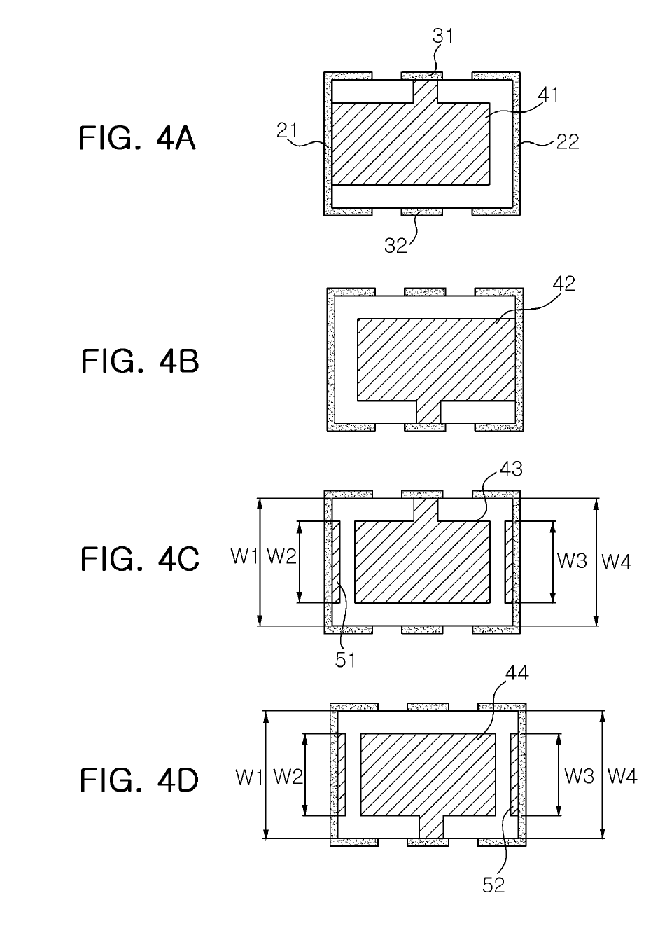

FIG. 1 is a perspective view showing an external appearance of a multilayer ceramic component according to an embodiment of the present invention. FIG. 2 is a plan view of each internal electrode taken along line A-A′ in FIG. 1 (in the case that a single dummy electrode is provided). FIG. 3 is an exploded perspective view of the internal electrodes of FIG. 1. FIG. 4 is a plan view of each internal electrode taken along line A-A′ in FIG. 1 (in the case that two dummy electrodes are provided).

Multilayer ceramic electronic components may include a multilayer ceramic capacitor, a chip inductor, chip beads, and the like. Hereinafter, a multilayer ceramic capacitor will be described as an example; however, the present invention is not limited thereto.

With reference to FIGS. 1 and 2, the multilayer ceramic electronic component according to an embodiment of the present invention may include a ceramic main body 10, first and second terminal electrodes 21 and 22, first and second external electrodes 31 and 32, first to fourth internal electrodes 41 to 44, and first and second dummy electrodes 51 and 52.

The ceramic main body 10 may have a rectangular parallelepiped shape. With reference to FIG. 1, it may be defined that the “L” direction may be a “length direction”, the “W” direction may be a “width direction”, and the “T” direction may be a thickness direction. Here, the ‘thickness direction’ may be the direction in which internal electrodes are laminated.

The length of the ceramic main body 10 may be greater than the width and the thickness thereof, and here, the width and the thickness may be equal.

The ceramic main body 10 may be made of a ceramic material having high permittivity. The ceramic main body 10 may be made of a barium titanate (BaTiO₃)-based material, a lead-composite perovskite-based material, a strontium titanate (SrTiO₃)-based material, or the like; however, the present invention is not limited thereto.

The ceramic main body 10 may be formed by laminating and sintering a plurality of ceramic dielectric layers 11, and here, adjacent dielectric layers 11 are integrated such that a boundary therebetween may not be readily discerned.

The first and second terminal electrodes 21 and 22 may be formed to face each other in the length direction on the ends of the ceramic main body 10, and electricity of mutually opposed polarities may be applied to the first and second terminal electrodes 21 and 22.

The first and second terminal electrodes 21 and 22 may be formed by using a conductive paste including conductive metal powder and glass frit, and the conductive metal may be copper (Cu), a copper alloy, nickel, a nickel alloy, silver, palladium, or the like; however, the present invention is not limited thereto.

The first and second external electrodes 31 and 32 may be formed to face each other in the width direction on the ceramic main body 10, and may be made of the same material as that of the first and second terminal electrodes.

FIG. 2 shows various types of internal electrodes. The internal electrodes may be four types of electrodes: first to fourth internal electrodes 41 to 44. FIGS. 2(a) to 2(d) are plan views of the first to fourth internal electrodes 41 to 44, showing connection relationships between the terminal electrodes 21 and 22 and the external electrodes 31 and 32.

With reference to FIG. 2(a), the first internal electrode 41 may be connected to the first terminal electrode 21 and the first external electrode 31.

Electricity applied from the outside may pass through the first terminal electrode 21 and the first internal electrode 41 sequentially, and flow to the first external electrode 31. Thus, ESR of the multilayer ceramic capacitor can be adjusted by appropriately designing the pattern of the first internal electrode 41. Namely, ESR can be increased by narrowing the width of the first internal electrode 41 or lengthening a path along which a current flows.

With reference to FIG. 2(b), the second internal electrode 42 may be connected to the second external electrode 32 and the second terminal electrode 22.

Electricity applied to the second terminal electrode 22 may pass through the second internal electrode 42 and flow to the second external electrode 32. Thus, ESR can be adjusted by selectively designing the shape of the pattern of the second inner electrode 42. This is no different from the case of the first internal electrode 41, and an operational effect may be the same, except that electricity of a polarity opposite to that of the first internal electrode 41 may flow through the second internal electrode 42.

With reference to FIG. 2(c), the third internal electrode 43 may only be connected to the first external electrode 31.

Electricity applied to the first terminal electrode 21 may pass through the first internal electrode 41 and the first external electrode 31 sequentially, and be applied to the third internal electrode 43. Thus, the first internal electrode 41 and the third internal electrode 43 may be charged with the same polarity.

With reference to FIG. 2(d), the fourth internal electrode 44 may only be connected to the second external electrode 32.

Electricity applied to the second terminal electrode 22 may pass through the second internal electrode 42 and the second external electrode 32 sequentially, and be applied to the fourth internal electrode 44. Thus, the second internal electrode 42 and the fourth internal electrode 44 may be charged with the same polarity.

In other words, since the first and third internal electrodes 41 and 43 are connected to the first external electrode 21, they may be charged with the same polarity. Since the second and fourth internal electrodes 42 and 44 are connected to the second external electrode 22, they may be charged with the same polarity. Thus, the first and third internal electrodes 41 and 43 may be charged with a polarity opposite to that of the second and fourth internal electrodes 42 and 44.

Hereinafter, lamination order of the first to fourth internal electrodes 41 to 44 will be described with reference to FIG. 3.

With reference to FIG. 3, the first, fourth, third, second, third, fourth, and first internal electrodes, starting from the uppermost electrode, may be laminated in order.

In FIG. 3, it is illustrated that a single third internal electrode 43 and a single fourth internal electrode 44 are formed between the first and second internal electrodes 41 and 42; however, the present invention is not limited thereto and a plurality of third and fourth internal electrodes 43 and 44 may be formed between the first and second internal electrodes 41 and 42.

The third and fourth internal electrodes 43 and 44 may be alternately laminated, and the first and second internal electrodes 41 and 42 may be disposed at upper and lower portions or at a certain middle portion of the lamination of the third and fourth internal electrodes 43 and 44.

In other words, a plurality of the third and fourth internal electrodes 43 and 44 may be laminated, and the first and second internal electrodes 41 and 42 may be disposed therebetween.

In order to implement a desired capacity, a plurality of the third and fourth internal electrodes 43 and 44 may be laminated and the first and second internal electrodes 41 and 42 may be appropriately positioned therebetween to thereby appropriately adjust ESR.

Preferably, neighboring internal electrodes may be disposed such that electricity of mutually opposed polarities is applied thereto.

The first and second internal electrodes 41 and 42 are used to adjust ESR by adjusting a current path, but here, neighboring internal electrodes may be disposed to have mutually opposed polarities to thus contribute to formation of capacitance.

With reference to FIGS. 2 and 3, a dummy electrode may be additionally formed on the internal electrode layer.

A dummy electrode may refer to an electrode (or a conductor) that does not contribute to capacitance.

The dummy electrode may include a first dummy electrode 51 connected to the first terminal electrode 21 and a second dummy electrode 52 connected to the second terminal electrode 22.

The dummy electrodes 51 and 52 may be formed on one or more of a layer on which the third internal electrode 43 is disposed (referred to as a ‘third internal electrode layer’, hereinafter) and a layer on which the fourth internal electrode 44 is disposed (referred to as a ‘fourth internal electrode layer’, hereinafter).

However, the present invention is not limited thereto, and a dummy electrode may also be formed on the first and second internal electrode layers.

With reference to FIGS. 2 and 3, any one of the first and second dummy electrodes 51 and 52 may be disposed on the third and fourth internal electrode layers.

The dummy electrodes disposed on the third and fourth internal electrode layers may overlap each other (i.e., the first dummy electrode 51 connected to the first terminal electrode 21 is disposed on both of the third and fourth internal electrode layers) or may be disposed in an alternating manner such that they do not overlap (i.e., the first dummy electrode 51 connected to the first terminal electrode 21 is disposed on the third internal electrode layer and the second dummy electrode 52 connected to the second terminal electrode 52 is disposed on the fourth internal electrode layer).

In the case that the dummy electrodes 51 and 52 are disposed in an alternating manner, a connection of the first dummy electrode 51 and the first terminal electrode 21 and a connection of the second dummy electrode 52 and the second terminal electrode 22 may be balanced, and accordingly, connectivity between the internal electrodes 41 to 44 and the external electrodes 31 and 32 may also be balanced overall.

A ratio of the length W2 of a connection portion in which the first dummy electrode 51 and the first terminal electrode 21 are connected (referred to as a ‘first connection portion’, hereinafter) to the width W1 of the first terminal electrode 21 and a ratio of the length W3 of a connection portion in which the second dummy electrode 52 and the second terminal electrode 22 are connected (referred to as a ‘second connection portion’, hereinafter) to the width W4 of the second terminal electrode 22 may range from 0.3 to 0.8.

If the ratio of the length of the first connection portion W2 to the width W1 of the first terminal electrode is less than 0.3, connectivity between the internal electrodes 41 to 44 and the external electrodes 31 and 32 (or between the terminal electrodes 21 and 22) would not be uniform and ESR dispersion would be large, and thus, stable electrical characteristics may not be obtained.

Meanwhile, if the ratio of the length of the first connection portion W2 to the width W1 of the first terminal electrode 21 exceeds 0.8, a defective electrode exposure could occur, to degrade reliability.

The first connection portion and the second connection portion may be collectively called a ‘connection portion’.

ESR dispersion may refer to an extent to which ESR values are dispersed.

As ESR dispersion is increased, the range at which the ESR is dispersed becomes broad, and stable ESR characteristics cannot be anticipated, degrading reliability. In the case that ESR dispersion is decreased, the range in which ESR is dispersed becomes narrow and stable ESR characteristics can be anticipated, enhancing reliability.

ESR dispersion may be calculated as follows.

Thirty multilayer ceramic capacitor (MLCC) chips may be prepared, an ESR value of each of the MLCC chips may be measured, an average and a standard deviation may be obtained, and a value obtained by dividing a double of the standard deviation by the average value may be determined as ESR dispersion.

The width W1 of the first terminal electrode 21 may be equal to the width W4 of the second terminal electrode 22. Also, the length W2 of the first connection portion may be equal to the length W3 of the second connection portion.

Accordingly, the fabrication process can be simplified, and the connectivity between the internal electrodes 41 to 44 and the external electrodes 31 and 32 (or the terminal electrodes 21 and 22) can be easily controlled.

FIG. 4 is a schematic view showing a case in which two dummy electrodes are formed on the third and fourth internal electrode layers.

With reference to FIG. 4, the first and second dummy electrodes 51 and 52 may be disposed together on the third internal electrode on which the third internal electrode 43 is disposed and on the fourth internal electrode layer on which the fourth internal electrode 44 is disposed.

Namely, the first and second dummy electrodes 51 and 52 may be disposed together on the third internal electrode layer, and at the same time, the first and second dummy electrodes 51 and 52 may be disposed together on the fourth internal electrode layer. Namely, two dummy electrodes are disposed on each of the internal electrode layers.

Preferably, a ratio of the length W2 of the first connection portion to the width W1 of the first terminal electrode 21 and a ratio of the length W3 of the second connection portion to the width W4 of the second terminal electrode 22 may range from 0.2 to 0.8.

If the ratio of the lengths W2 and W3 of the connection portions to the widths W1 and W4 of the terminal electrodes 21 and 22 is less than 0.2, connectivity between the internal electrodes 41 to 44 and the external electrodes 31 and 32 (or the terminal electrodes 21 and 22) is not uniform, increasing ESR dispersion to result in a failure of stable electrical characteristics.

Meanwhile, if the ratio of the lengths W2 and W3 of the connection portions to the widths W1 and W4 of the terminal electrodes 21 and 22 exceeds 0.8, a defective electrode exposure occurs to degrade reliability.

The dummy electrodes 51 and 52 may be divided into a plurality of parts so as to be formed (not shown).

So long as the ratio of the lengths W2 and W3 of the connection portions to the widths W1 and W4 of the terminal electrodes 21 and 22 is maintained to be within the foregoing range, the dummy electrodes 51 and 52 may be divided into a plurality of parts so as to be formed.

With reference to FIG. 3, the first, fourth, third, second, third, fourth, and first internal electrodes are disposed sequentially from the above.

Electricity of mutually opposed polarities may be applied to the first and second terminal electrodes 21 and 22. Electricity applied to the first terminal electrode 21 may pass through the first internal electrode 41 and the first external electrode 31 sequentially, to reach the third internal electrode 43.

Electricity applied to the second terminal electrode 22 may pass through the second internal electrode 42 and the second external electrode 32 sequentially, to reach the fourth internal electrode 44.

The third internal electrode 43 and the fourth internal electrode 44 are charged with mutually opposed polarities, and capacitance may be formed between the third internal electrode 43 and the fourth internal electrode 44.

Also, the neighboring first and fourth internal electrodes 41 and 44 may be charged with mutually opposed polarities, and the neighboring second and third internal electrodes 42 and 43 may be charged with mutually opposed polarities.

Accordingly, capacitance may be formed between the first and fourth internal electrodes 41 and 44 and between the second and third internal electrodes 42 and 43.

The dummy electrodes 51 and 52 do not contribute to capacitance. The first or second dummy electrode 51 or 52 disposed on the third internal electrode layer and the first or second dummy electrode 51 or 52 disposed on the fourth internal electrode layer does not contribute to capacitance.

In the case that the first dummy electrode 51 connected to the first terminal electrode 21 is disposed on the third internal electrode layer and the second dummy electrode 52 connected to the second terminal electrode 22 is disposed on the fourth internal electrode layer, since the first and second dummy electrodes 51 and 52 do not overlap, they do not contribute to capacitance.

In the case that the first dummy electrode 51 or the second dummy electrode 52 is disposed on both of the third and fourth internal electrode layers, although the dummy electrodes overlap each other, since the polarities of electricity charged in the dummy electrodes are identical, so the dummy electrodes do not contribute to capacitance.

To sum up, in the case that the dummy electrode disposed on the third internal electrode layer and the dummy electrode disposed on the fourth internal electrode layer overlap each other, they have the same polarity, and in the case that the polarities are different, the dummy electrodes do not overlap, so the dummy electrodes do not contribute to a formation of capacitance.

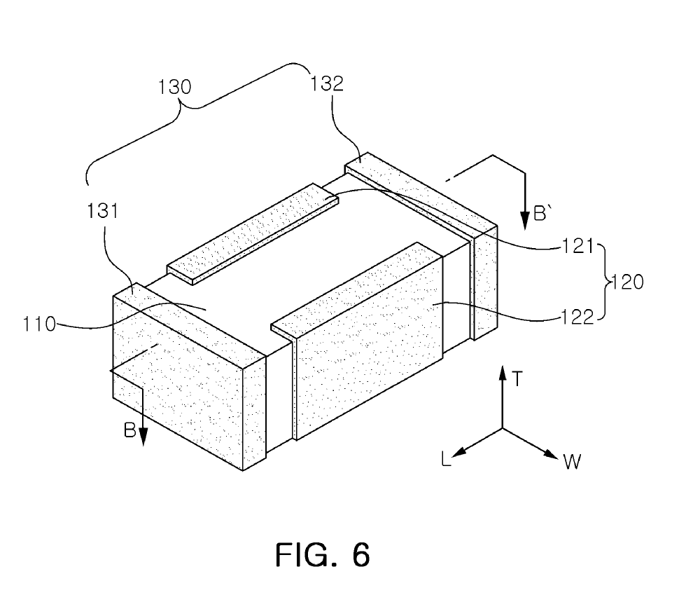

Another embodiment of the present invention will be described with reference to FIGS. 6 through 9.

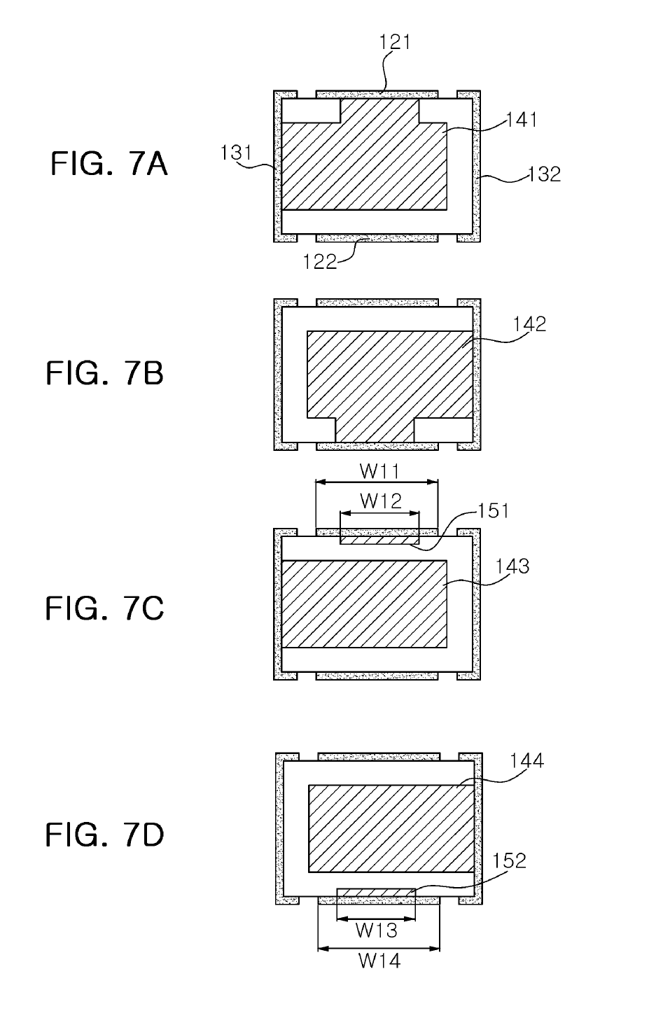

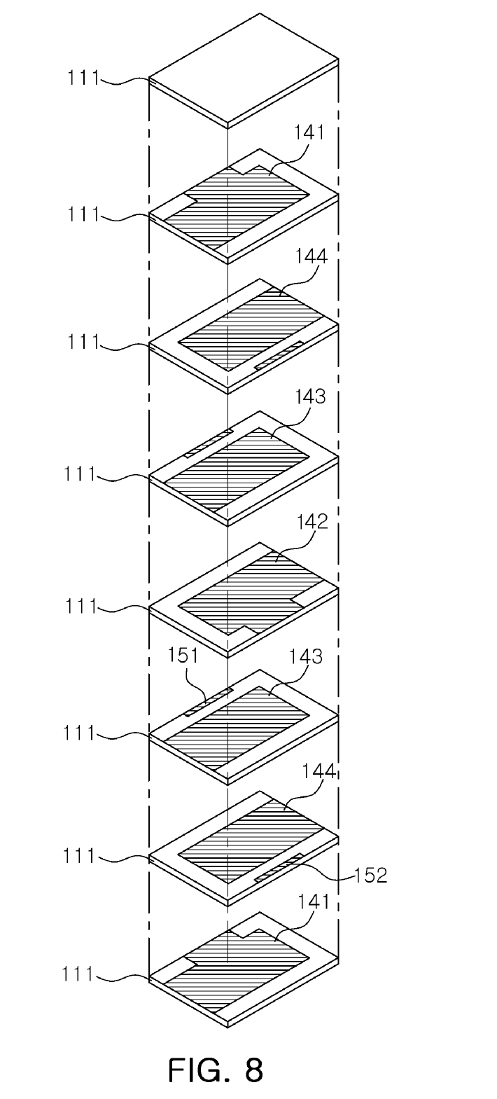

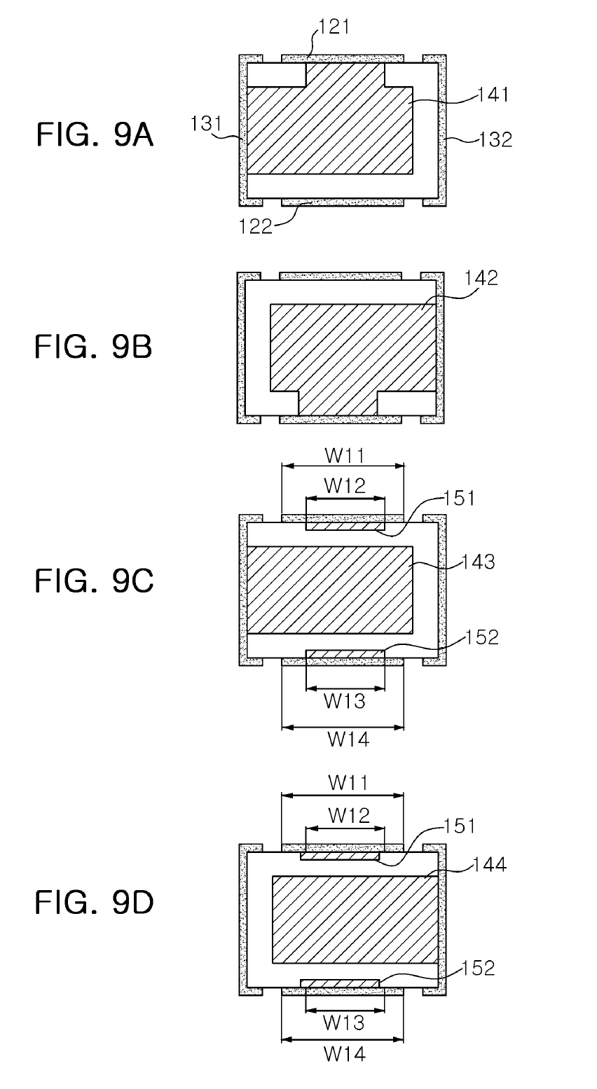

FIG. 6 is a perspective view showing an external appearance of a multilayer ceramic component according to another embodiment of the present invention. FIG. 7 is a plan view of each internal electrode taken along line B-B′ in FIG. 6 (in the case that a single dummy electrode is provided). FIG. 8 is an exploded perspective view of each internal electrode of FIG. 1. FIG. 9 is a plan view of each internal electrode taken along line B-B′ in FIG. 6 (in the case that two dummy electrodes are provided).

With reference to FIGS. 6 and 7, a multilayer ceramic electronic component according to the present embodiment may include a ceramic main body 110, first and second terminal electrodes 121 and 122, first and second external electrodes 131 and 132, first to fourth internal electrodes 141 to 144, and first and second dummy electrodes 151 and 152.

The ceramic main body 110 may have a rectangular parallelepiped shape. In FIG. 6, it may be defined that the “L” direction may be a “length direction”, the direction may be a “width direction”, and the “T” direction may be a thickness direction. Here, the ‘thickness direction’ may be the direction in which internal electrodes are laminated.

The length of the ceramic main body 110 may be greater than the width and the thickness thereof, and here, the width and the thickness may be equal.

In the present embodiment, the first and second terminal electrodes 121 and 122 may be disposed to face each other in the width direction of the ceramic main body 110, and the first and second external electrodes 131 and 132 may be disposed to face each other in the length direction of the ceramic main body 110.

FIG. 7 illustrates a case in which a single dummy electrode is disposed on third and fourth internal electrode layers. FIG. 7 shows various types of internal electrodes. The internal electrodes may be four types of electrodes: first to fourth internal electrodes 141 to 144.

FIGS. 7(a) to 7(d) are plan views of the first to fourth internal electrodes 141 to 144, showing connection relationships between the terminal electrodes 121 and 122 and the external electrodes 131 and 132.

With reference to FIG. 7(a), the first internal electrode 141 may be connected to the first terminal electrode 121 and the first external electrode 131.

Electricity applied from the outside may pass through the first terminal electrode 121 and the first internal electrode 141 sequentially, and flow to the first external electrode 131. Thus, ESR of the multilayer ceramic capacitor can be adjusted by appropriately designing the pattern of the first internal electrode 141. Namely, ESR can be increased by narrowing the width of the first internal electrode 141 or lengthening a path along which a current flows.

With reference to FIG. 7(b), the second internal electrode 142 may be connected to the second external electrode 132 and the second terminal electrode 122.

Electricity applied to the second terminal electrode 122 may pass through the second internal electrode 142 and flow to the second external electrode 132. Thus, ESR can be adjusted by appropriately designing the shape of the pattern of the second inner electrode 142. This is no different from the case of the first internal electrode 141, and an operational effect may be the same, except that electricity of a polarity opposed to that of the first internal electrode 141 flows through the second internal electrode 142.

With reference to FIG. 7(c), the third internal electrode 143 may only be connected to the first external electrode 131.

Electricity applied to the first terminal electrode 121 may pass through the first internal electrode 141 and the first external electrode 131 sequentially, and be applied to the third internal electrode 143. Thus, the first internal electrode 141 and the third internal electrode 143 may be charged with the same polarity.

With reference to FIG. 7(d), the fourth internal electrode 144 may only be connected to the second external electrode 132.

Electricity applied to the second terminal electrode 122 may pass through the second internal electrode 142 and the second external electrode 132 sequentially, and be applied to the fourth internal electrode 144. Thus, the second internal electrode 142 and the fourth internal electrode 144 may be have a charge having the same polarity.

In other words, since the first and third internal electrodes 141 and 143 are connected to the first terminal electrode 121, they may be charged with the same polarity. Since the second and fourth internal electrodes 142 and 144 are connected to the second terminal electrode 122, they may be charged with the same polarity. Also, the first and third internal electrodes 141 and 143 may be charged with a polarity opposite to that of the second and fourth internal electrodes 142 and 144.

Hereinafter, lamination order of the first to fourth internal electrodes 141 to 144 will be described with reference to FIG. 8.

With reference to FIG. 8, the first, fourth, third, second, third, fourth, and first internal electrodes, starting from the uppermost one, may be laminated.

In FIG. 8, it is illustrated that a single third internal electrode 143 and a single fourth internal electrode 144 are formed between the first and second internal electrodes 141 and 142; however, the present invention is not limited thereto and a plurality of third and fourth internal electrodes 143 and 144 may be formed between the first and second internal electrodes 141 and 142.

The third and fourth internal electrodes 143 and 144 may be alternately laminated, and the first and second internal electrodes 141 and 142 may be disposed at upper and lower portions or at a certain middle portion of the lamination of the third and fourth internal electrodes 143 and 144.

In other words, a plurality of the third and fourth internal electrodes 143 and 144 may be laminated, and the first and second internal electrodes 141 and 142 may be disposed therebetween.

In order to implement a desired capacity, a plurality of the third and fourth internal electrodes 143 and 144 may be laminated and the first and second internal electrodes 141 and 142 may be appropriately positioned between the third and fourth internal electrodes 143 and 144 to thereby appropriately adjust ESR.

Preferably, neighboring internal electrodes may be disposed such that electricity of mutually opposed polarities is applied thereto.

The first and second internal electrodes 141 and 142 are used to adjust ESR by adjusting a current path, but here, neighboring internal electrodes may be disposed to have mutually opposed polarities to thus contribute to formation of capacitance.

With reference to FIGS. 7 and 8, any one of the first and second dummy electrodes 151 and 152 may be disposed on the third and fourth internal electrode layers.

The dummy electrodes disposed on the third and fourth internal electrode layers may overlap each other (i.e., the first dummy electrode 151 connected to the first terminal electrode 121 is disposed on both of the third and fourth internal electrode layers) or may be disposed in an alternating manner such that they do not overlap (i.e., the first dummy electrode 151 connected to the first terminal electrode 121 is disposed on the third internal electrode layer and the second dummy electrode 152 connected to the second terminal electrode 122 is disposed on the fourth internal electrode layer).

In the case that the dummy electrodes 151 and 152 are disposed in an alternating manner, a connection of the first dummy electrode 151 and the first terminal electrode 121 and a connection of the second dummy electrode 152 and the second terminal electrode 122 may be balanced, and accordingly, connectivity between the internal electrodes 141 to 144 and the external electrodes 131 and 132 may also be balanced overall.

A ratio of the length W12 of a connection portion in which the first dummy electrode 151 and the first terminal electrode 121 are connected (referred to as a ‘first connection portion’, hereinafter) to the width W11 of the first terminal electrode 121 and a ratio of the length W13 of a connection portion in which the second dummy electrode 152 and the second terminal electrode 122 are connected (referred to as a ‘second connection portion’, hereinafter) to the width W14 of the second terminal electrode 122 may range from 0.4 to 0.8.

If the ratio of the length of the first connection portion W12 to the width W11 of the first terminal electrode 121 is less than 0.4, connectivity between the internal electrodes 41 to 44 and the external electrodes 131 and 132 (or between the terminal electrodes 121 and 122) would not be uniform and ESR dispersion would be increased, and thus, stable electrical characteristics may not be obtained.

Meanwhile, if the ratio of the length of the first connection portion W12 to the width W11 of the first terminal electrode 121 exceeds 0.8, a defective electrode exposure would occur to degrade reliability.

The width W11 of the first terminal electrode 121 may be equal to the width W14 of the second terminal electrode 122. Also, the length W12 of the first connection portion may be equal to the length W13 of the second connection portion.

Accordingly, the fabrication process can be simplified, and the connectivity between the internal electrodes 141 to 144 and the external electrodes 131 and 132 (or the terminal electrodes 121 and 122) can be easily controlled.

In comparison to the former embodiment, stable electrical characteristics can be obtained in the case that the ratio of the lengths W12 and W13 of the connection portions to the widths W11 and W14 of the terminal electrodes 121 and 122 is 0.3 or more, but in the present embodiment, the ratio is required to be 0.4 or more to obtain stable electrical characteristics.

FIG. 9 is a schematic view showing a case in which two dummy electrodes are formed on the third and fourth internal electrode layers.

With reference to FIG. 9, the first and second dummy electrodes 151 and 152 may be disposed together on the third internal electrode on which the third internal electrode 143 is disposed and on the fourth internal electrode layer on which the fourth internal electrode 144 is disposed.

Namely, the first and second dummy electrodes 151 and 152 may be disposed together on the third internal electrode layer, and at the same time, the first and second dummy electrodes 151 and 152 may be disposed together on the fourth internal electrode layer. Namely, two dummy electrodes are disposed on each of the internal electrode layers.

Preferably, a ratio of the length W12 of the first connection portion to the width W11 of the first terminal electrode 121 and a ratio of the length W13 of the second connection portion to the width W4 of the second terminal electrode 122 may range from 0.3 to 0.8.

If the ratio of the lengths W12 and W13 of the connection portions to the widths W11 and W14 of the terminal electrodes 121 and 122 is less than 0.3, connectivity between the internal electrodes 141 to 144 and the external electrodes 131 and 132 (or the terminal electrodes 121 and 122) is not uniform, increasing ESR dispersion to result in a failure of stable electrical characteristics.

Meanwhile, if the ratio of the lengths W12 and W13 of the connection portions to the widths W11 and W14 of the terminal electrodes 121 and 122 exceeds 0.8, a defective electrode exposure occurs to degrade reliability.

In comparison to the former embodiment, stable electrical characteristics can be obtained in the case that the ratio of the lengths W12 and W13 of the connection portions to the widths W11 and W14 of the terminal electrodes 121 and 122 is 0.2 or more, but in the present embodiment, the ratio is required to be 0.3 or more to obtain stable electrical characteristics.

The dummy electrodes 151 and 152 may be divided into a plurality of parts so as to be formed (not shown), and the first to fourth internal electrodes 141 to 144 and the first and second dummy electrodes 151 and 152 may be made of the same material.

So long as the ratio of the lengths W12 and W13 of the connection portions to the widths W11 and W14 of the terminal electrodes 121 and 122 is maintained to be within the foregoing range, the dummy electrodes 151 and 152 may be divided into a plurality of parts so as to be formed.

In comparison to the former embodiment, in the present embodiment, the positions of the terminal electrodes and the external electrodes are interchanged. In comparison to the former embodiment, in the present embodiment, the distance between the first and second terminal electrodes 121 and 122 may be short. In the present embodiment, a current loop is reduced to result in obtaining a negative effect in which the ESL is lowered.

However, in comparison to the former embodiment, in the present embodiment, since the positions of the terminal electrodes and the external electrodes are interchanged, wide ESR can be implemented, and also, since the current path is shortened, ESR can be lowered.

### Embodiment

Hereinafter, the present invention will be described specifically through embodiments. A multilayer ceramic capacitor (MLCC) was prepared and ESR dispersion was measured and compared according to the following method.

The MLCC was prepared as follows.

Dielectric slurry containing barium titanate as a main ingredient was prepared through ball milling, and a dielectric green sheet was fabricated with the dielectric slurry through a doctor blade method. A conductive paste containing nickel as a main ingredient was printed on the dielectric green sheet to form first to fourth internal electrodes and dummy electrodes.

The dielectric green sheets with the internal electrodes and the dummy electrodes printed thereon were laminated, pressed, and then, cut to fabricate a green chip. The green chip was sintered to fabricate a fired chip. External electrodes containing copper as a main ingredient were formed on an outer surface of the fired chip through dipping and printing methods.

Table 1 shows ESR dispersion measured over an MLCC in which first and second dummy electrodes were not disposed on each of third and fourth electrode layers, an MLCC in which only one of the first and second dummy electrodes was disposed on each of the third and fourth electrode layers (the first and second dummy electrodes were disposed in an alternating manner), and an MLCC in which both of the first and second dummy electrodes were disposed on each of the third and fourth electrode layers.

TABLE 1

| | The number of types of | |
|---|---|---|
| Classification | dummy electrodes | ESR dispersion (%) |
| Comparative Example 1 | None | 240 |
| Embodiment Example 1 | One | 18 |
| Embodiment Example 2 | Two | 16 |

With reference to Table 1, Comparative Example 1 shows a case in which no dummy electrode was disposed, and ESR dispersion was 240%. Embodiment Example 1 shows a case in which one dummy electrode was disposed and ESR dispersion was 18%. Embodiment Example 3 shows a case in which two dummy electrodes were disposed, and ESR dispersion was 16%.

In the case that dummy electrode was disposed, ESR dispersion was significantly reduced in comparison to the case without a dummy electrode, but in the case that two dummy electrodes were disposed, the degree of reducing ESR dispersion was small in comparison to the case of one dummy electrode.

It can be seen from Table 1 that a factor greatly affecting the characteristics of ESR dispersion was the presence or absence of a dummy electrode and the number of dummy electrodes does not greatly affect the characteristics of ESR dispersion (namely, the influence of the number of dummy electrodes on the characteristics of ESR dispersion was small).

Table 2 shows ESR dispersion characteristics according to a ratio of the lengths W2 and W3 of the connection portions to the widths W1 and W4 of the terminal electrodes.

A chip was 1608-sized (1.6 mm×0.8 mm×0.8 mm), two layers of each of the first and fourth internal electrodes 41 and 44 were configured, and ESR value was determined to be 500 mΩ. The width W1 of the first terminal electrode was equal to the width W4 of the second terminal electrode, and the length W2 of the first connection portion and the length W3 of the second connection portion were equal. One of the first and second dummy electrodes 51 and 52 or both of them were formed on the second and third internal electrode layers.

TABLE 2

| | The | | Ratio of length of | |
|---|---|---|---|---|
| | number | Length of | connection portion in | |
| | of types | connec- | which terminal electrode | ESR |
| | of dummy | tion | and dummy electrode are | disper- |
| Classifi- | elec- | portion | connected to width of | sion |
| cation | trodes | (μm) | terminal electrode | (%) |
| Comparative | 1 | 80 | 0.10 | 42 |
| Example 3 | | | | |
| Comparative | | 160 | 0.20 | 27 |
| Example 4 | | | | |
| Embodiment | | 240 | 0.30 | 19 |
| Example 3 | | | | |
| Embodiment | | 320 | 0.40 | 14 |
| Example 4 | | | | |
| Embodiment | | 400 | 0.50 | 11 |
| Example 5 | | | | |
| Comparative | 2 | 80 | 0.10 | 36 |
| Example 5 | | | | |
| Embodiment | | 160 | 0.20 | 20 |
| Example 6 | | | | |
| Embodiment | | 240 | 0.30 | 16 |
| Example 7 | | | | |
| Embodiment | | 320 | 0.40 | 12 |
| Example 8 | | | | |
| Embodiment | | 400 | 0.50 | 10 |
| Example 9 | | | | |

* Exceeding the range of the present invention

With reference to Table 2, in case in which a single dummy electrode was formed on the third and fourth internal electrodes, respectively, in the case that the ratio of the length of the connection portion in which the terminal electrode and the dummy electrode were connected to the width of the terminal electrode was 0.30 or more, ESR dispersion was smaller than 20% to exhibit stable electrical characteristics (Embodiment Examples 3 to 5).

In case in which two dummy electrodes were formed on the third and fourth internal electrode layers, respectively, in the case that the ratio of the length of the connection portion in which the terminal electrode and the dummy electrode were connected to the width of the terminal electrode was more than 0.20, ESR dispersion was smaller than 20% to exhibit stable electrical characteristics (Embodiment Examples 6 to 9).

Stable electrical characteristics can be obtained in the case that the ratio of the length of the connection portion to the width of the terminal electrode was 20% or more in case of two dummy electrodes and 30% or more in case of one dummy electrode, and accordingly, it can be confirmed that stable electrical characteristics can be obtained, even in the case that two dummy electrodes are provided, in comparison to the case in which a single dummy electrode is provided, although the ratio of the length of the connection portion to the width of the terminal electrode is small.

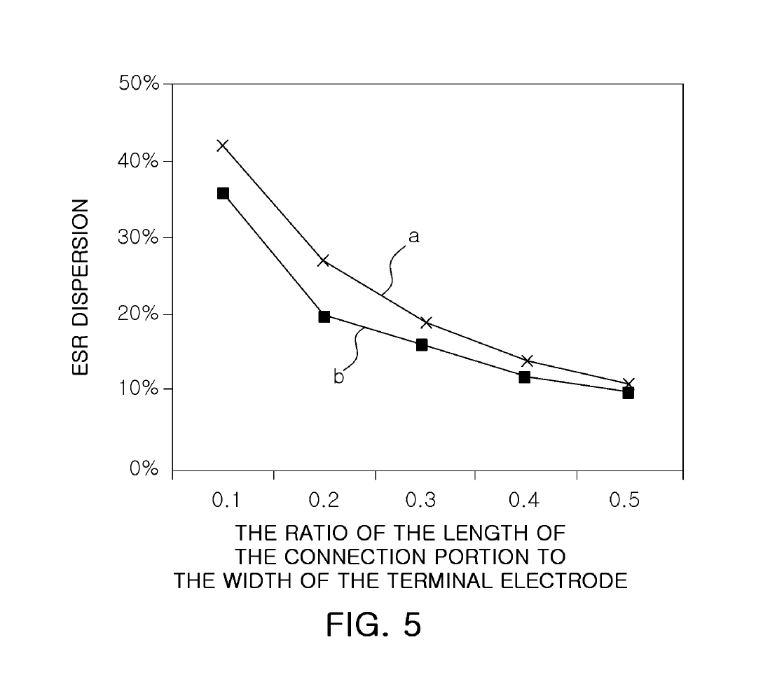

FIG. 5 is a graph of ESR dispersion of Table 2.

FIG. 5(a) shows the case of a single dummy electrode, and FIG. 5(b) shows the case of two dummy electrodes.

With reference to FIG. 5, it is noted that ESR dispersion is gradually reduced as the ratio of the length of the connection portion to the width of the terminal electrode is increased.

Also, it is noted that in the case of the two dummy electrodes (FIG. 5(b)), ESR dispersion was smaller in comparison to the case of the single dummy electrode (FIG. 5(a)). Thus, it can be considered that the presence of two dummy electrodes can obtain stable electrical characteristics and enhance reliability.

Table 3 below shows characteristics of ESR dispersion in the case that the positions of the terminal electrodes and the external electrodes were interchanged according to another embodiment of the present invention (See FIG. 6).

Two layers of each of the first and fourth internal electrodes 141 and 144 were configured, and ESR was determined to be 200 mΩ. The width W11 of the first terminal electrode and the width W14 of the second terminal electrode was equal to be 800 μm, and the length W12 of the first connection portion and the length W13 of the second connection portion was equal. One of the first and second dummy electrodes 151 and 152 or both of them were formed on the second and third internal electrode layers.

TABLE 3

| | The | | Ratio of length of | |
|---|---|---|---|---|
| | number | Length of | connection portion in | |
| | of types | connec- | which terminal electrode | ESR |
| | of dummy | tion | and dummy electrode are | disper- |
| Classifi- | elec- | portion | connected to width of | sion |
| cation | trodes | (μm) | terminal electrode | (%) |
| Comparative | 1 | 80 | 0.10 | 42 |
| Example 3 | | | | |
| Comparative | | 160 | 0.20 | 27 |
| Example 4 | | | | |
| Embodiment | | 240 | 0.30 | 19 |
| Example 3 | | | | |
| Embodiment | | 320 | 0.40 | 14 |
| Example 4 | | | | |
| Embodiment | | 400 | 0.50 | 11 |
| Example 5 | | | | |
| Comparative | 2 | 80 | 0.10 | 36 |
| Example 5 | | | | |
| Embodiment | | 160 | 0.20 | 20 |
| Example 6 | | | | |
| Embodiment | | 240 | 0.30 | 16 |
| Example 7 | | | | |
| Embodiment | | 320 | 0.40 | 12 |
| Example 8 | | | | |
| Embodiment | | 400 | 0.50 | 10 |
| Example 9 | | | | |

* Exceeding the range of the present invention

With reference to Table 3, in case in which a single dummy electrode was formed on the third and fourth internal electrodes, respectively, in the case that the ratio of the lengths W12 and W13 of the connection portions to the widths W11 and W14 of the terminal electrodes was 0.40 or more, ESR dispersion was smaller than 20% to exhibit stable electrical characteristics (Embodiment Examples 11 and 12).

In case in which two dummy electrodes were formed on the third and fourth internal electrode layers, respectively, in the case that the ratio of the lengths of the connection portions to the widths of the terminal electrodes was more than 0.30, ESR dispersion was smaller than 20% (Embodiment Examples 12 to 14).

Stable electrical characteristics can be obtained in the case that the ratio of the length of the connection portion to the width of the terminal electrode was 30% or more in case of two dummy electrodes and 40% or more in case of one dummy electrode, and accordingly, it can be confirmed that stable electrical characteristics can be obtained in the case that two dummy electrodes are provided, in comparison to the case in which a single dummy electrode is provided, although the ratio of the length of the connection portion to the width of the terminal electrode is small.

As set forth above, according to embodiments of the invention, since ESR dispersion is small, a multilayer ceramic electronic component having high reliability can be obtained.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic electronic component comprising:
a ceramic main body in which internal electrodes are disposed in a laminated manner;
first and second terminal electrodes formed lengthwise on the ceramic main body; and
first and second external electrodes formed widthwise on the ceramic main body,
wherein the internal electrodes include a first internal electrode connected to both of a first terminal electrode and a first external electrode, a second internal electrode connected to both of a second external electrode and a second terminal electrode, a third internal electrode connected only to the first external electrode, and a fourth internal electrode connected only to the second external electrode, and
a first dummy electrode connected to the first terminal electrode or a second dummy electrode connected to the second terminal electrode are disposed on at least one of a layer on which the third internal electrode is disposed and a layer on which the fourth internal electrode is disposed.

2. The multilayer ceramic electronic component of claim 1, wherein any one of the first and second dummy electrodes is disposed on the layer on which the third internal electrode is disposed and the layer on which the fourth internal electrode is disposed.

3. The multilayer ceramic electronic component of claim 2, wherein the first and second dummy electrodes are disposed in an alternating manner such that they do not overlap each other.

4. The multilayer ceramic electronic component of claim 2, wherein a ratio of the length of a connection in which the first dummy electrode and the first terminal electrode are connected to the width of the first terminal electrode and a ratio of the length of a connection portion in which the second dummy electrode and the second terminal electrode are connected to the width of the second terminal electrode range from 0.3 to 0.8.

5. The multilayer ceramic electronic component of claim 1, wherein the first and second dummy electrodes are disposed together on the layer on which the third internal electrode is disposed and on the layer on which the fourth internal electrode is disposed.

6. The multilayer ceramic electronic component of claim 5, wherein a ratio of the length of a connection in which the first dummy electrode and the first terminal electrode are connected to the width of the first terminal electrode and a ratio of the length of a connection portion in which the second dummy electrode and the second terminal electrode are connected to the width of the second terminal electrode range from 0.2 to 0.8.

7. The multilayer ceramic electronic component of claim 1, wherein the first and second dummy electrodes are divided into a plurality of parts.

8. The multilayer ceramic electronic component of claim 1, wherein the first to fourth internal electrodes and the first and second dummy electrodes are made of the same material.

9. A multilayer ceramic electronic component comprising:
a ceramic main body in which internal electrodes are disposed in a laminated manner;
first and second external electrodes formed lengthwise on the ceramic main body; and
first and second terminal electrodes formed widthwise on the ceramic main body,
wherein the internal electrodes include a first internal electrode connected to both of a first terminal electrode and a first external electrode, a second internal electrode connected to both of a second external electrode and a second terminal electrode, a third internal electrode connected only to the first external electrode, and a fourth internal electrode connected only to the second external electrode, and
a first dummy electrode connected to the first terminal electrode or a second dummy electrode connected to the second terminal electrode are disposed on at least one of a layer on which the third internal electrode is disposed and a layer on which the fourth internal electrode is disposed.

10. The multilayer ceramic electronic component of claim 9, wherein any one of the first and second dummy electrodes is disposed on the layer on which the third internal electrode is disposed and the layer on which the fourth internal electrode is disposed.

11. The multilayer ceramic electronic component of claim 10, wherein the first and second dummy electrodes are disposed in an alternating manner such that they do not overlap each other.

12. The multilayer ceramic electronic component of claim 10, wherein a ratio of the length of a connection in which the first dummy electrode and the first terminal electrode are connected to the width of the first terminal electrode and a ratio of the length of a connection portion in which the second dummy electrode and the second terminal electrode are connected to the width of the second terminal electrode range from 0.4 to 0.8.

13. The multilayer ceramic electronic component of claim 9, wherein the first and second dummy electrodes are disposed together on the layer on which the third internal electrode is disposed and on the layer on which the fourth internal electrode is disposed.

14. The multilayer ceramic electronic component of claim 13, wherein a ratio of the length of a connection in which the first dummy electrode and the first terminal electrode are connected to the width of the first terminal electrode and a ratio of the length of a connection portion in which the second dummy electrode and the second terminal electrode are connected to the width of the second terminal electrode range from 0.3 to 0.8.

15. The multilayer ceramic electronic component of claim 9, wherein the first and second dummy electrodes are divided into a plurality of parts.

16. The multilayer ceramic electronic component of claim 9, wherein the first to fourth internal electrodes and the first and second dummy electrodes are made of the same material.
